(19) United States
(12) Patent Application Publication
(10) Pub. No.: US 2011/0266011 A1
(43) Pub. Date: Nov. 3, 2011

(54) MOBILE TUBE NOZZLE FIREFIGHTING SENSOR PUMP FOR A FIREFIGHTING PRODUCT FOR PREVENTING DISASTERS

(76) Inventor: Woo Sung Lee, Busan (KR)

(21) Appl. No.: 13/143,917

(22) PCT Filed: Sep. 15, 2010
(86) PCT No.: PCT/KR2010/006287

§ 371 Date: Jul. 8, 2011

(30) Foreign Application Priority Data
Sep. 16, 2009 (KR) 10-2009-0088090

(51) Int. Cl. A62C 3/02; A62C 35/11

(52) U.S. Cl. 169/52

(57) ABSTRACT

Disclosed is a mobile tube nozzle firefighting sensor pump for a firefighting product for preventing disasters, which is configured with a plurality of hoses and tube bodies (firefighting products for preventing disasters) within a mobile tube nozzle firefighting sensor pump body, and paraffin (for fire detection) tape and paraffin type tube joints and nozzle covers formed on gaps in the firefighting tube nozzle and nozzle forming holes. Such mobile tube nozzle firefighting sensor pumps for products for preventing disasters are respectively installed in a wire rope-type cable car configuration on high and low mountains, on mountain ridge environs below mountain peaks, and on rooftop of high and low buildings near beaches. Accordingly, in order to reduce danger in urgent and dire situations and the danger of a loss of life, the senor pump can perform simple extinguishing in the early stages of a fire before fire trucks or helicopters can be dispatched.

### TECHNICAL FIELD

The present invention relates to a mobile tube nozzle firefighting sensor pump for a firefighting product for prevention disasters which make it possible to prevent a lift-losing situation in emergency and provide an initial fire extinguishing operation before a firefighting car or a firefighting helicopter arrive,

in such a way that a mobile tube nozzle type firefighting sensor pump for a cable car type non-disaster firefighting product is installed at each ridge of each low and high mountain in an integral configuration and at a top of each low and high building near beach with the aid of a construction that a firefighting tube nozzle gap and a nozzle formation hole formed of a plurality of firefighting prevention measure products and a tube body are provided in the interior of a tube nozzle movement type firefighting sensor pump body, and a paraffin tape of a fire detection sensor and a nozzle cap for a paraffin type tube joint nozzle connection are provided.

### BACKGROUND ART

Fire extinguishing facility, is typically, classified into an extinguisher, an additional extinguishing facility as a spring cooler facility at an extinguishing facility and a fire alarm facility.

The above facilities are regulated a fire extinguishing law and a regulation of a fire prevention condition of each city on their installation standards.

In order to extinguish at early stage of fire in an easier and simple way, a fire extinguisher is preferred. The installations of the fire extinguisher at a place such as a school, a hotel, a restaurant or somewhere else where a lot of people come in and go out are regulated as a law for the installation at a building. The operations of the fire extinguisher might be classified into the following.

First, the supply of the air (oxygen) is blocked by surrounding burning materials with a nonflammable gas based on a non-oxygen supply operation, thus preventing burning.

Second, burning materials are cooled to a temperature below an ignition point. The above two methods are typically used at the same time.

It is, however, hard to extinguish the fire at an initial state with the above methods and systems, whereby fire increases more in the above method.

### DISCLOSURE OF INVENTION

Accordingly, it is an object of the present invention to provide a mobile tube nozzle type firefighting sensor pump of a non-disaster firefighting measure product which makes it possible to extinguish fire at an initial stage before a firefighting car or a firefighting helicopter arrives while preventing a life-losing situation in an emergency,

in such a way that a mobile tube nozzle type firefighting sensor pump of a non-disaster firefighting measure product of a cable car type of a wire rope type is installed at a ridge of each low and high mountain and a top of each low and high building near a beach in an integral construction.

To achieve the above objects, there is provided,

In a conventional firefighting sensor pump,

there are provided a firefighting sensor pump body 1 which is formed of a motor body 192 disposed in the interior of a firefighting sensor pump boy 1, and

a pump with an impeller 148 disposed around a center circular portion of a shaft 198 formed at a horizontal center line (MBCL) of the motor body 192 and a guide vane 142 disposed at both outer surfaces of the impeller, and

a main valve formed of a piston 127 pimp attached to the shaft 198 of the pump in which the valve 142 is not attached, and a pump turbine 264 of a generator 213 of a power plant integral with the body of the generator disposed at a side surface of the generator, and

an upright type multi-stage pump 8 of a type of a plurality of micro computer control methods which is formed of a plunger pump 198 disposed at a balance nozzle turbine 267 and a pump 140 of the interior of pelton turbine 230 of the Francis turbine and a plunger pump 198 at the pump 140, and a propeller pump 146 and a viscosity pump 343 both disposed at a high pressure piston pump 127, and a plurality of driving force motors 198 separable from the shaft of the inner side of each pump boy casing 141; and

the firefighting sensor pump body 1 which is formed of an upright multi-stage pump 8 with a plurality of isolation valves 5 formed inside and outside, and

a valve assembly having a fluid pressure and flow amount control and flow amount direction adjusting functions in an auto method in the check valve 6, and a second pressure detection sensor 87 formed at an auto valve control sensor and a first pressure detection sensor 86, and a sensor switch assembly for intermitting the flow in the interior of a pipe with respect to all disaster prevention materials, and which is characterized in that a carbon dioxide 174 and a fire extinguisher 124 at an inflammable gas 164, and a firefighting sand 159 at a red clay 158, and a gas container 171 for storing helium gas 176, and a plurality of water collection tanks 34, and a plurality of pressure tanks (head tanks 189), and a plurality of water storing tanks 295, and a high water level tank 295, and at a sealed type upper side of the tank, and

a manhole lid 153 and hatch cover 154, and a bolt 24 and a screw tap 167 are disposed at a plurality of tank manholes, and

a gasket 32 attached to a lid 153 and a process hole 20, and a bolt is fixed at using a hand tool spanner, and a plurality of water storing tanks 295 are disposed at each ridge of the peak of a mountain in a stair type or an open type, and a plastic pack or a camping type tent 43 is disposed, and an ignition detection stripe 41 is installed in a movable way along with the tent 43, and a wire 178 is made of:

a non-ignition material wire 178, and the wire is connected at the plastic pack or the central portion of the camping tent and the knot of the plastic pack, and it is fixedly hung at the tent fixing type frame, and

the stripes 41 are connected at four corners of the tent, totally eight portions, and a plurality of plastic pack water tanks 295 are installed along ridges of a mountain depending on the heights of the mountain, and the mobile types of the tube nozzle 10 of the firefighting disaster prevention pipe line 168 and the firefighting nozzle 10 inside or outside of a plurality of pressure tanks 189 and a plurality of water collection tanks 34 are classified into the basic type 1 and the basic type 2 depending on the standards of the standard type firefighting hose 9, and

the tube nozzle 10 connected with the junction firefighting nozzle of the flange 28 and the firefighting tube nozzle of the junction portion of the coupling 29 is formed of a plurality of the mobile type tube nozzle at the firefighting cable car 256; and

the firefighting sensor pump body 1 is formed in such a manner that the cable car 256 is assembled by installing the steel towers 116 for the operations of the car 256 at each portion of the firefighting operation room 394 and along the ridges of the lower side of the ground surface GLL of the low or high mountain 395 and the peak of the same, and

the portions near beaches and the roof of the low or high rise building, and the steel tower 116 is fixed with an anchor bolt 133 using a hand-held tool, and a driving wheel roller 135 and a pulley 256 formed of a plurality of wire ropes 19 are installed at the upper sides of the steel tower, and the winch 137 is installed at each portion of the peak of the mountain and the firefighting operation room 394 of the roof of the building below the steel tower 116, and

the winch 137 receives the power of the transformer 96 and the electric pole 95 connected via electric cables with respect to the driving power 46 generated from the generator 213 or the engine generator 226 of the power plant 267 below the cable car 256, and there are provided the motored driving force motor 192 having a micro control function, and a plurality of the driving force motor 192 and the control module 106 with the sensor detections of a plurality of electronic valves at a plurality of compressors, and the firefighting cable car 256 is formed of the hole 20 of the firefighting tube nozzle 10 distributing the weights of the thing of the firefighting water 7 in the interior of the firefighting hose 9 in the water collection tank 34 of the plastic tent 43 integrally formed at the pump fire extinguisher 124 attached to the wire rope 19, and an air ship 78 and a rope 131 are connected with a plurality of ad balloons 77, respectively, above the life rescue basket 42; and

the driving motor 198 of the pump 8 is attached to the upper surfaces of the upright type multi-stage pump 8 and the diaphragm pump 144, and

the diaphragm pump (ordinary pump) 144 is formed in such a manner that the piston 127 and the cylinder 126 are attached to a crank handle formed of the crank 248 and the link 249 on the rubber membrane or the upper side of the Teflon membrane 538, and

the air receiver storing tank 145 formed of the air compressor 80 and the air tube line 181 formed of the air hose 109 and the nipple 110 is configured so that the gas container 171 storing the disaster prevention materials in the intercooler 170 and the pump fire extinguisher 124 after mounting it at the firefighting cable car 256, and is engaged in the interior of the firefighting sensor pump body 1.

### ADVANTAGEOUS EFFECTS

The mobile tube nozzle type firefighting sensor pump of a no-disaster firefighting disaster prevention measure product according to the present invention can be applied to a no-disaster firefighting disaster prevention product as a firefighting and a firefighting disaster prevention management apparatus which are directed to preventing huge disasters related with heavy snow, typhoon, cold, flood, drought, landslide or something else within almost one second and obtaining firefighting and preventing the propagation of bugs and insects with the aid of muddy water mixed with red clay,

and are directed to a life saver in case of mountain fire and huge fire with the aid of an inner structure of a pump body based on an operation with a firefighting cable car.

### BRIEF DESCRIPTION OF THE DRAWINGS

The present invention will become better understood with reference to the accompanying drawings which are given only by way of illustration and thus are not limitative of the present invention, wherein;

FIG. 1 is a view of an inner construction of a boy of a mobile tube nozzle type firefighting sensor pump of a no-disaster firefighting disaster prevention measure product according to the present invention;

FIG. 2 is a front cross sectional view of an installation position of a water collection pump and a firefighting elevator of an elevator machinery room according to the present invention;

FIG. 3 is a view of an installation and operation method of a wire rope, a spray nozzle and a firefighting hose according to the present invention;

FIG. 4 is a view of an installation method of a water supply apparatus tap water connection pump fire extinguisher at a building top tank and a pressure tank according to the present invention;

FIG. 5 is a view of an installation method of a carbon dioxide based on an installation of a tube nozzle water collection tank of a stair type non-motored water hammer pump according to the present invention;

FIG. 6 is a view of a miniature of a multi-tube firefighting hose and a spray nozzle miniature assembly and an assembling procedure according to the present invention;

FIG. 7 is a view of a construction of an ordinary faucet of a water item of all adjusting valves and tube accessories according to the present invention;

FIG. 8 is an enlarged cross sectional view of major portions of the present invention; and

FIG. 9 is a perspective view of a plurality of valve constructions formed at a firefighting pump and an air compressor according to the present invention.

### DESCRIPTIONS OF REFERENCE NUMERALS

1: firefighting sensor pump body
127: piston
140: pump
143: impeller
142: guide vane
192: motor body
198: shaft
213: generator
230: pennon turbine

### MODES FOR CARRYING OUT THE INVENTION

The preferred embodiments of the mobile tube nozzle firefighting sensor pump for a firefighting product for prevention disasters according to the present invention will be descried with reference to the accompanying drawings.

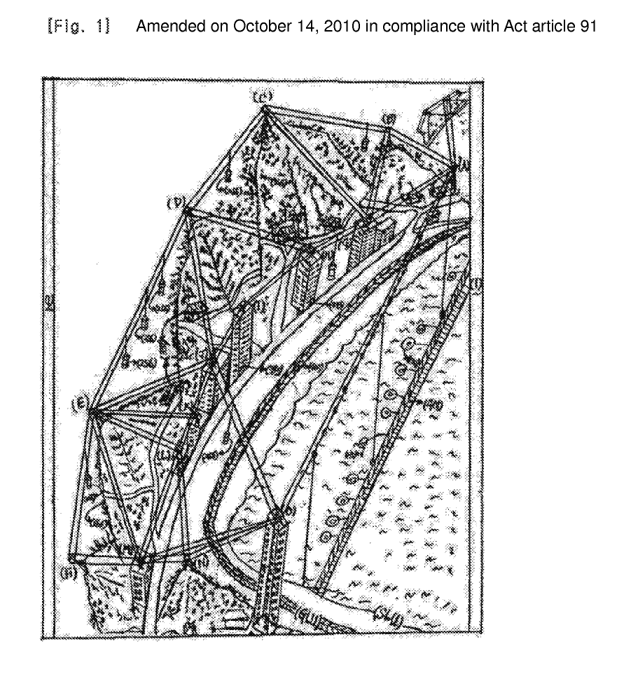

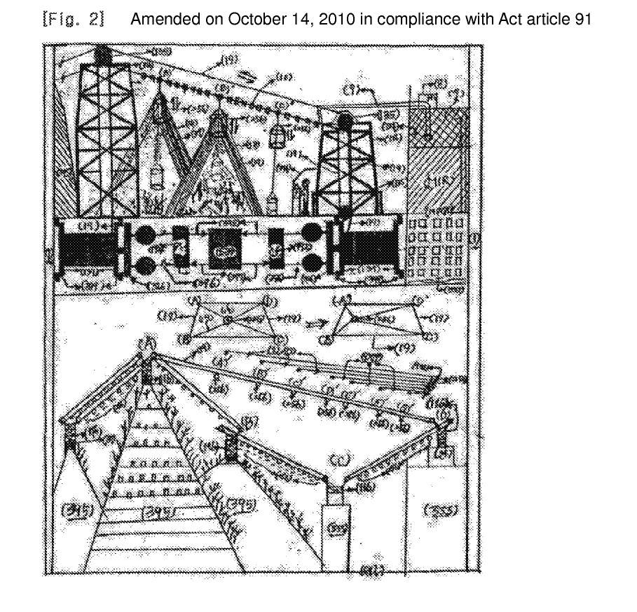

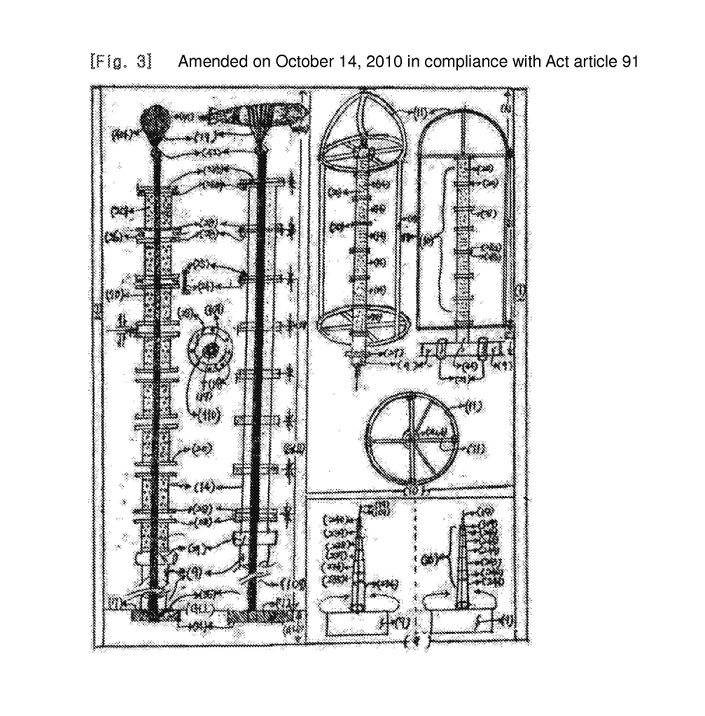

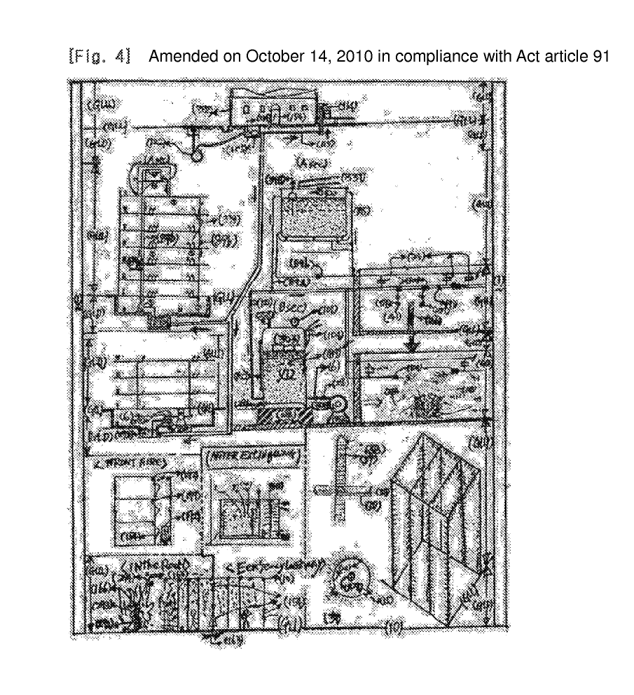

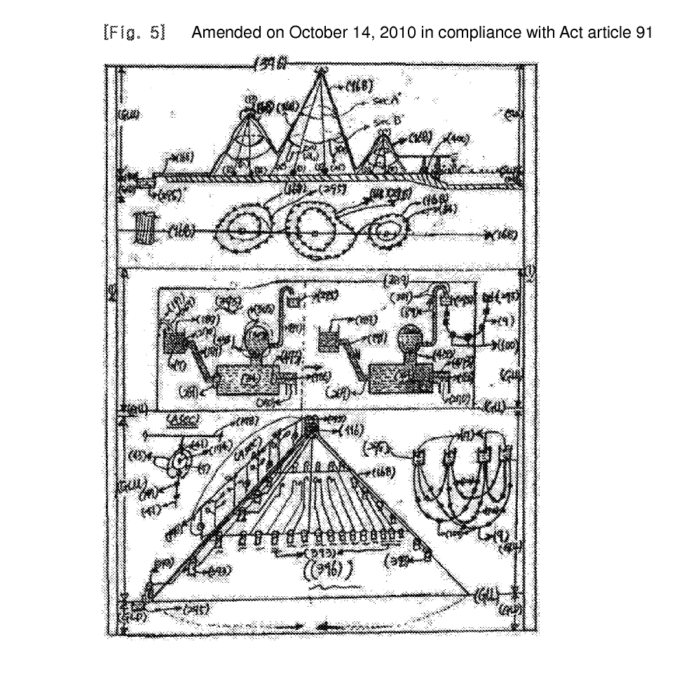

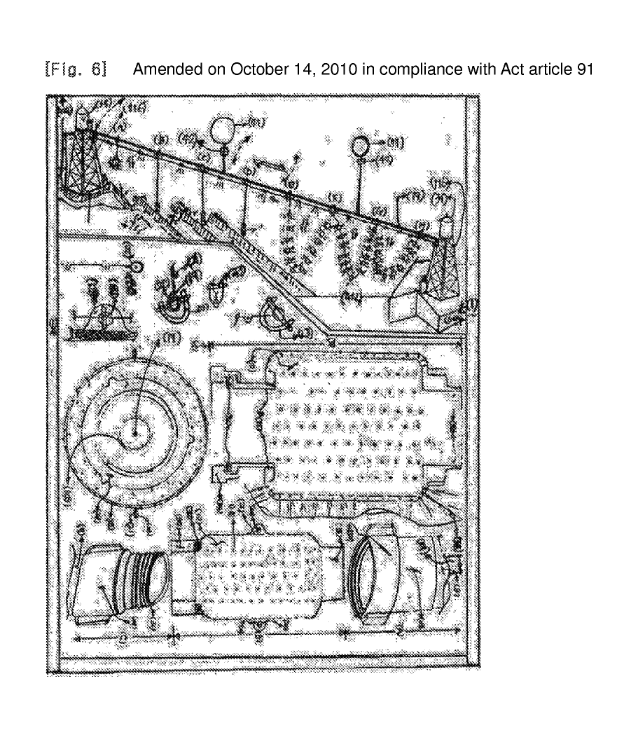

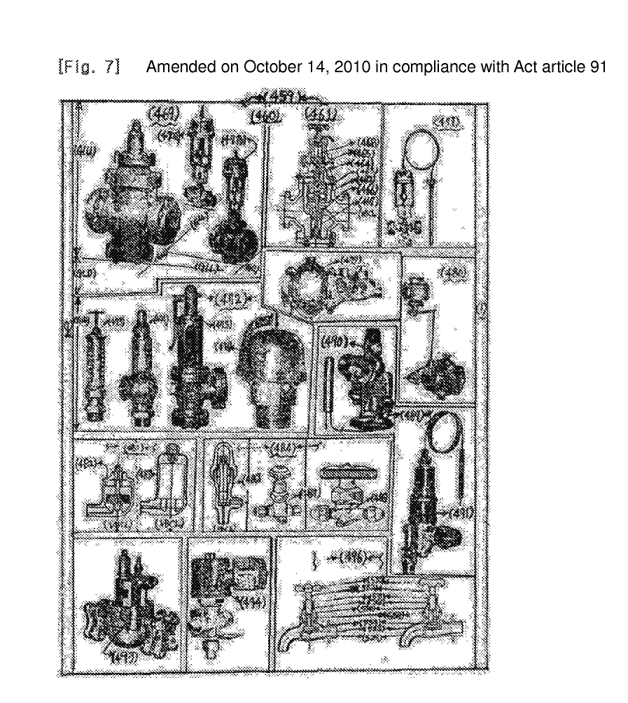

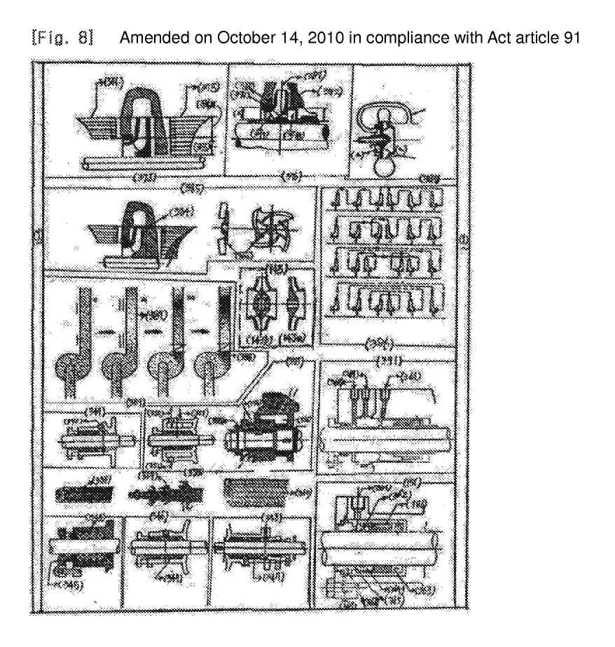

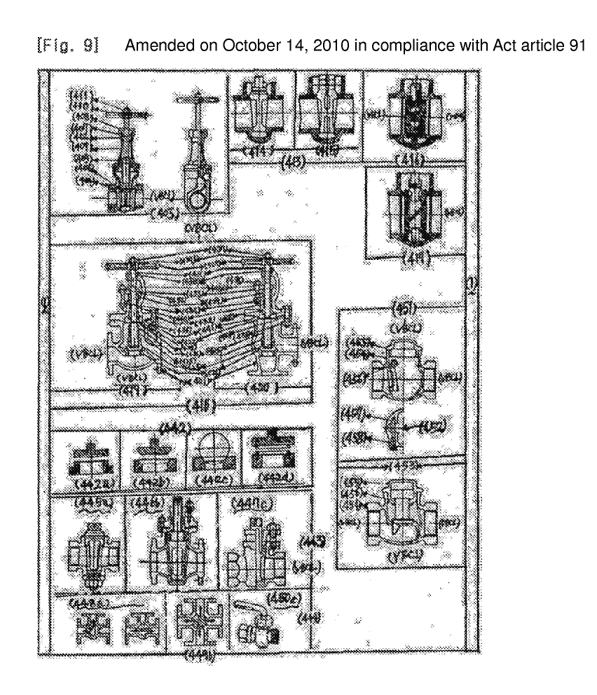

FIGS. 1 to 9 are views of a mobile tube nozzle firefighting sensor pump for a firefighting product for prevention disasters according to the present invention which comprises:

a head tank 189, a solenoid valve 76, a firefighting water 7, a firefighting sand 159 in a red clay 158, a plurality of detection sensors 105 provided in a chamber of a high pressure upright type multi-stage pump 8, a driving force power supply device 46 of a pump control system 150, a high pressure upright-type multi-stage control box 2,

a control board 53 in the interior of the control box, an inverter 47 in a management server 51, a switch button 66 for a pump operation with a wire rope 19 in the power unit 62,

a water collection tank 34 which is a firefighting water storing tank in a hook rug 21 a pipe connection accessory reducer 35, a basket 42 in a high performance underwater pump 36,

a wireless communication antenna 54, and a local name computer network input 68 in a portable communication terminal 82,

the construction that a brake 61 is installed, with the aid of a plastic bag 43 and a hook 18, at a firefighting pipe connection accessory elbow or T-elbow 44 and a monitor 52 in the same as the conventional art.

A spiral casing 141 is provided in the interior of the firefighting sensor pump body 1 as a protection cover of the body of a plurality of pumps 8,

an impeller 143 is installed at a guide vane 142, and the kinds and characteristics of the pump attached of a central shaft of the shaft 198 of the motor body 192 are considered, and

the kind of the pump is selected, and the pump based on the revolution of the impeller is determined, and the shaft rod device of the pump, and measures are prepared based on the vibrations of the pump, and the handing procedure of the compressor compressing gas is prepared, and a firefighting disaster prevention equipment is provided in a mobile tube nozzle firefighting sensor pump for a firefighting product for prevention disasters, all the elements of which are directed to achieving no disasters in the world. The detailed constructions of the present invention will be described.

A firefighting tube nozzle 10 formed of a plurality of firefighting disaster prevention product of a hose 9 and a tube body 14 in the interior of the mobile tube nozzle firefighting sensor pump for a firefighting product for prevention disasters according to the prevention, and a gap are provided, and

a nozzle process hole 20 is formed, and a paraffin tape 177 of an ignition detection sensor is provided, and

a mobile tube nozzle type firefighting sensor pump of a wire rope 19 and a firefighting cable car 256 type of a no-disaster firefighting disaster prevention item are installed at low and high mountains 395 and each ridge below the peak of a mountain and a roof of a high or row rising building 333 near a sea beach along with a paraffin type tube joint nozzle connection nozzle cap 100, and when flammable type fire occurs at a wooden building 332 of a building belonging to an ordinary fire and a forest belonging to the kind of fire A such as paper and blanket,

in the conventional way, a helicopter 500 and a firefighting car 402 of a fire car blare sirens and start to a fire site. At this time, at the time when such cars come in and go out avoiding obstacles ahead such as an illegal parking on the street which interferes with traffic flow, almost dead fire becomes alive again, and for some reasons, a fire extinguishing word is delayed at the fire site, and one second delay might ignite a big fire, and lives might be lost in emergency situations due to a big fire, and the mobile tube nozzle firefighting sensor pump for a firefighting product for prevention disasters is directed to extinguishing fire within one second at an initial stage before a firefighting or a firefighting helicopter arrives, thus saving lives and preventing dangers.

The sealed multi-pipes nozzle gap holes filled with a plurality of no-disaster paraffin nozzle caps 100 and paraffin tapes 177 formed in the hose 9 of the sensor pump 1 and the nozzle pump 10 are directed to preventing fire spreading to a huge fire as the fire thermal detection sensor paraffin prevents fire caused by a match fire 166 or a candle fire by a low temperature detection, and

Fire can be extinguished at an initial stage, and the mobile tube nozzle firefighting sensor pump for a firefighting product for prevention disasters according to the present invention is implemented in such a manner that a flammable or burning thing is sealed by an inflammable gas (not burnt gas), thus blocking air (oxygen) in an airway obstruction method or a cooling operation that the flammable is lowered to a temperature below an ignition level, within almost one second when fire occurs with the aid of an acid alkali extinguisher 124b and a foam type extinguisher 124b in a pump extinguisher 124e with respect to a fire A.

The fire is extinguished by a cooling operation that water is poured using a hose, thus saving lives, and the mobile tube nozzle firefighting sensor pump for a firefighting product for prevention disasters 124 makes it possible to obtain a live shaving and an initial stage extinguishing from a mountain fire and a huge fire which occur by the seasons.

The firefighting water 7 and the red clay 158 are inputted into the water collection tank 34 with a mixer 73 (hopper) along with a firefighting sand 159, and a fire extinguishing device of an intercooler 170 is configured in the pump 144 (ordinary pump) and the compressor 80.

As the flammable material 166 burns, and the inflammable gas 164 stored in the interiors of a plurality of the fire extinguishers along with the firefighting water with an anti-water pressure in the firefighting hose in the interior of the firefighting tube nozzle body, and

is discharged to the outside of the fire extinguisher body, and the discharge spray water 38 and the curtain water screen 39 from the gap 15 of the firefighting nozzle 10 surround the flame 294, thus extinguishing fire quickly, and such operations are transmitted to the unmanned camera 184 installed at an electric pole around the fire site, and

the microcomputer control is formed of a digital control type inverter 47 and a speed control method and an algebra control method, the microcomputer control designed to display the fire scenes on the monitor 52 with the aid of the information detection function of the pump management server 51 of the management system 150 of the upright type multi-stage pump 8.

A certain amount of firefighting materials formed of the impeller 143 is inputted into the inlet in the interior of the spiral casing 310 of a plurality of pump bodies in the interior of the firefighting pump bodies, and the impeller 143 is engaged to the shaft 198, which is a driving motor rotation center shaft and rotates, and the anti-water pressure of the firefighting water 7 with the aid of an industrial site machine room inner pump left side compressing and storing the anti-water pressure of the firefighting water 7, and

the right side head tank 189, a plurality of firefighting disaster prevention tube line 168 of the transfer device of a certain amount of the firefighting water 7, a firefighting water path 17 of a certain standard and function, and

a dual structure water collection tank 34 arranged at a certain distance with a slope angle 16 of the disaster prevention water path 17, and

a bowl tap 499 which is a detection sensor for detecting the water level of the firefighting water in the interior of the water collection tank 34, and a cap filter flange cap steel net 28 of the suction port 269 of the firefighting water 7 for blocking the input of foreign substance into the interior of the water collection tank 34, and

a plurality of solenoid valves 76 which are open when the switch button is on, and which are closed when the switch button is off, and

a coupling 29 is engaged to the T elbow 44 of the coupling device to induce the halon gas 175, and a low pressure blocking valve 83 is provided for blocking when it is induced via the rear end of the disaster prevention tub 14, and

a high pressure upright type multi-stage pump 8 formed of a mixer (hopper 73) is provided to mix the disaster material carbon dioxide 164 and a natural red clay 158, and a driving force control module 106 operates, and

the firefighting water flows through the pipe connection accessory T elbow 44 and the disaster prevention pipe 14 connected with the reducer 35 via the flange 28, and the gap 15, the process hole 20 and the gap of the junction portions of the flanges 28 are connected to the nozzle hose 9.

the firefighting water 7 helps distribute the weights of the firefighting cable car 256 with the aid of the buoyancy of the ad balloon 77 and the airship 78 at a higher position in the shape of the 490 circular straight discharge spray water 38 or the curtain water screen 39 along with eight water screens, thus extending a lifespan of the facility, and the red clay mixture is discharged via the tube nozzle 10, and

thus preventing the fire all over the world and a huge fire inside or outside the building even after the occurrence of disaster, thus extinguishing fire within one second, and the system is configured to pump almost 50 times the head drop with t non-motored pump which is a water hammer pump 393 based on the flow of the fluid, and there is provided an air compressor 80 reciprocating at a high speed, and

a two-stage screw compressor 80 is integrally engaged to distribute heat to the oil cooler 157 without using the intercooler 170 and the after cooler 182 using a certain connection part, and the air tube 730 formed of the suction port 269 and the discharge port 270 is engaged with the life jacket basket 42 and the bed nozzle 172 used for the purpose of the life saving, and the disaster prevention red clay 158 and the firefighting sand 159 and the air storing plastic bag belong to the disaster prevention part, and

The check valve 6 and the isolation valve 5 are provided to pump 50 times the head drop with the aid of the control operation in which the fluid can move based on the air pressure formed in the pressure tank (high pressure bowl tank 303) of the interior of the non-motored pump 303, thus extinguishing fire at an initial stage at the peak of the mountain which are configured in the interior of the firefighting sensor pump body 1 in the valve system connection apparatus formed of a pressure control valve of the mobile tube nozzle type of the non-disaster prevention measure items and the flow amount control valve in the direction control valve opening and closing in the interior of the firefighting sensor pump body 1.

There are provide a first pressure check sensor 86 installed in front of the isolation valve 5, and

a second pressure check senor 87 installed in integration with the pressure release valve, and

a detour disaster prevention pipe line 168 installed to detour by connecting the front and rear sides of the isolation valve 5 with respect to the isolation valve 5, and

an emergency valve 84 installed to open and close reversely to the isolation valve 5 in the detour disaster prevention pipe line 168, and

all the elements of the electronic control unit 88 controlling the emergency valve 84 by checking the pressure values from the first pressure check sensor 86 and the second pressure check sensor 87, and

a solenoid valve 76 of a connection junction portion of the flange 28 of the suction joint tube 3 of the upper side of the road ground surface of the lower side of the upright type multi-stage pump 8, and the water level of the firefighting water in the water collection tank 34 at the upper side of the pump machine room is detected by a bowl tap 499 which is a firefighting water level detection sensor, and

an air hose 109 installed in the interior of the nozzle hose 9, and a socket air nipple 110 formed of male and female parts which are connected or disconnected by a joint of the air hose 109, and

an ad balloon 77 serves to save lives before and after the disaster at the roof of the building, and as the engine generator 226 at the inner upper side of the machine room is driven to make the airship 78 afloat, and the driving force power 46 is supplied to the air compressor 80 and the driving force motor control module 106, and the air generated by means of the air compressor is applied so that a certain pressure level of air is stored in the interior of the high pressure storing tank 145 of the air receiver, and a certain level of air pressure is formed in the interior of the air receiver high pressure storing tank 145, and the emergency value 84 of the disaster air tube management line 181 in emergency is opened, and air is blown into the interior of the building, and a pipe frame is attached to an outer side of the building.

Air is stored in the air tube 130 as sixed as the dimensions of the plurality of the containers, and the aid balloon 77 of the roof of the outdoor building becomes afloat to save lives, and the rescuers and the riding structures are confirmed in the life saving basket 42, so it is possible to cope with an emergency situation, and

a facility manufacture and installation method of a tube nozzle safety control apparatus facility and an equipment of a life saving part designed to prevent huge mountain fires all over the world are installed in the firefighting tube nozzle along with a paraffin sensor nozzle cap 100, and

a firefighting unit 40 and a fire extinguishing unit 179 are installed at mountains and buildings, and are standardized to prevent any disasters in the world, and are extended along with a tub line, and the air tube line 181 is connected with the firefighting cable car 256 in integration with a detection sensor switch a pump extinguisher 124 and at each valve thus extinguishing flame 293 and flame column 294 within one second by providing a mobile tube nozzle firefighting sensor pump apparatus.

the kinds and characteristics of the pump will be described along with the functions of the pumps clearly set for their opening and closing positions of the inner side of the positive displacement pump according to the present invention, which are the same as the transfers of fluid by a certain amount.

A fixed amount of fluid is pumped up by a piston of a reciprocation type pump or a plunger and is pushed, the features of which are as follows.

First, a high pressure can be obtained using a small size structure, and the present invention is good at a small amount of flow with a high viscosity, and

second, a liquid sending operation is intermittent with pulses, and a flat wheel might be needed to obtain a constant rotation speed in order to reduce the same, and an air chamber is needed, and in case of a high pressure, it is needed to attach an accumulator, and third since the amount of discharge during one stroke is constant, which results in a fixed amount of discharge and transmission.

Next, even when the revolution changes, the change of the discharge pressure is small, and since there are suction discharge valves, the number of parts increases, and the failure of valve is important, and as a mechanism for converting a rotational fore into a reciprocating movement, there is a crank method or an action method a result of which the parts are complicated, and it might contribute to a failure.

The kinds of reciprocating pumps are as follows.

First, the piston pump is configured like a sealant (packing) and a valve are attached to the piston, and second the plunger pump is characterized in that a sealant is fixed at a pump body, not being attached to a plunger which reciprocates, differently from the piston type pump.

Therefore, the plunger 253 is easy to change packing while obtaining a very high pressure.

The pump is configured like a motor is provided in the roof water collection tank 34 of the interior of the machine room of a large size building roof, and the winch 137 and the wire rope 19 are provided at the motor 192 of the decelerator 251, and the elevator (not shown) is provided in the building, and a switch button is triggered for an upper and lower side of the building, thus starting operation. The disaster prevention water 7 of the firefighting disaster management line 168 is designed to operate all the time irrespective of weather conditions along with the equipments of the body of the pump extinguisher, and the red clay 158 and the fire extinguisher 159 are activated in case of fire at mountains and roads along with a diaphragm pump 144.

The diaphragm pump 144 can pump water containing fluids, muddy water or sand.

As rubber membrane or Teflon membrane 538 moves up and down, thus performing a suction and discharge operation and is characterized in that a crank 248 and a link member 249 are provided at an upper side of the rubber membrane 538 on the upper surface of the pump 144, thus preventing easier abrasion and breaks of fluids containing sludgy (particles), which helps an initial extinguishing of mountain fire.

Therefore, it is possible to prevent leakage in full without using a grand packing, so the present invention is good at chemical agents or harmful fluids and is directed to a disaster prevention purpose of no damages and disasters in preparation with fire or other things.

The wing pump is a simple pump which makes it possible to move a handle in a left or right direction and is formed of two rooms called a suction room and a discharge room and can be easily engaged to a wall or something and is, generally, used to move oil from a drum container and to pump out water from the bottom of a ship.

In order to effectively move the equipment previously installed, there is provided a firefighting sensor pump body 1 mounted at the firefighting cable car 256 similar with the elevator and formed of a plurality of pumps, and

a roof firefighting operation room 394 in which the winch 137 receives an air from the air compressor 80 and allows the air block valve to open, so the winch 137 uses the air, and

a driving wheel roller 135 is provided at a steel tower 116 of the lower or higher mountain 395, and a polar and cord 396 and a speed command 397 are provided at the winch control box 53, and the wire rope is wound with the aid of the threads of the motor speed or transformer 398, and a disk brake 399 playing as a role of the brake is provided, so the hydraulic cylinder 126, the pneumatic cylinder 126 and the motor 192 are integral with each other.

The rotary pump 357 is one of a positive displacement pump. When the rotor of the body rotates, fluid is inputted into between the body (casing) and the rotor and is pushed and discharged.

It is needed to confuse the rotary pump with a centrifugal force pump, and the features of the same are as follows. First, it does not have a suction discharge valve like the reciprocating pump, and continuous discharge is obtained, thus no pulses.

Second, a high pressure discharge is possible.

Third, the present invention is well applied to a fluid with viscosity (oil, fat and oil, tar, pitch, paint, etc).

The higher the viscosity the fewer the revolution, the stronger the driving force. In case of high pressure, it is needed to necessarily install the safety valve.

The liquid without having viscosity is best applied to the centrifugal force pump.

The gear pump is a pump designed to suck when a pair of engaged gears are open and to discharge when closed using a plurality of gears and is characterized in that, first, it is well adapted to transferring liquid with a high viscosity, and

Second, it is well adapted to a high pressure, and even when a discharge pressure changes, the amount of discharge does not largely change, and

Third, liquid is not largely agitated like a centrifugal force pump, and

Fourth, a structure is simple, and a disassembling and cleaning are easy, and washing is also easy, and

Fifth, since abrasion is promoted by liquid containing particles, so it cannot be used for liquid containing solid particles.

The plane gear (spur gear) has a simple structure, and process is easy, and price is low, which leads to a wide range of use. Noises and vibrations are present a little, and a bearing is easy to damage, and durability is not good.

As compared to that, it is hard to process a helical gear with a torsion slope and a double helical gear for offsetting a propelling force of the helical operation (force moving back in an axial direction), and price is high, but no noises and no vibrations occur.

The gear pump can be classified, depending on the shape of gear, into an external gear pump 326a and an internal gear pump 326b.

The present invention is not limited by the above disclosed embodiments and might be modified or changed by one of an ordinary skill, and such modification is included in a concept and range of the invention.

1. A mobile tube nozzle firefighting sensor pump for a firefighting product for prevention disasters in a firefighting sensor pump, comprising:
a firefighting sensor pump body 1 which is formed of a motor body 192 disposed in the interior of a firefighting sensor pump boy 1, a pump with an impeller 148 disposed around a center circular portion of a shaft 198 formed at a horizontal center line (MBCL) of the motor body 192 and a guide vane 142 disposed at both outer surfaces of the impeller, a main valve formed of a piston 127 pimp attached to the shaft 198 of the pump in which the valve 142 is not attached, and a pump turbine 264 of a generator of a power plant integral with the body of the generator disposed at a side surface of the generator, and an upright type multi-stage pump 8 of a type of a plurality of micro computer control methods which is formed of a plunger pump 198 disposed at a balance nozzle turbine 267 and a pump 140 of the interior of pelton turbine 23 of the Francis turbine and a plunger pump 198 at the pump 140, and a propeller pump 146 and a viscosity pump 343 both disposed at a high pressure piston pump 127, and a plurality of driving force motors 198 separable from the shaft of the inner side of each pump boy casing 141; and
said firefighting sensor pump body 1 which is formed of an upright multi-stage pump 8 with a plurality of isolation valves 5 formed inside and outside, and a valve assembly having a fluid pressure and flow amount control and flow amount direction adjusting functions in an auto method in the check valve 6, and a second pressure detection sensor 87 formed at an auto valve control sensor and a first pressure detection sensor 86, and a sensor switch assembly for intermitting the flow in the interior of a pipe with respect to all disaster prevention materials, and which is characterized in that a carbon dioxide 174 and a fire extinguisher 124 at an inflammable gas 164, and a firefighting sand 159 at a red clay 158, and a gas container 171 for storing helium gas 176, and a plurality of water collection tanks 34, and a plurality of pressure tanks (head tanks 189), and a plurality of water storing tanks 295, and a high water level tank 195, and at a sealed type upper side of the tank, a manhole lid 153 and hatch cover 154, and a bolt 24 and a screw tap 167 are disposed at a plurality of tank manholes, and a gasket 32 attached to a lid 153 and a process hole 20, and a bolt is fixed at using a hand tool spanner, and a plurality of water storing tanks 295 are disposed at each ridge of the peak of a mountain in a stair type or an open type, and a plastic pack or a camping type tent 43 is disposed, and an ignition detection stripe 41 is installed in a movable way along with the tent 43, and a wire 178 is made of a non-ignition material wire 178, and the wire is connected at the plastic pack or the central portion of the camping tent and the knot of the plastic pack, and it is fixedly hung at the tent fixing type frame, and the stripes 41 are connected at four corners of the tent, totally eight portions, and a plurality of plastic pack water tanks 295 are installed along ridges of a mountain depending on the heights of the mountain, and the mobile types of the tube nozzle 10 of the firefighting disaster prevention pipe line 168 and the firefighting nozzle 10 inside or outside of a plurality of pressure tanks 189 and a plurality of water collection tanks 34 are classified into the basic type 1 and the basic type 2 depending on the standards of the standard type firefighting hose 9, and the tube nozzle 10 connected with the junction firefighting nozzle of the flange 28 and the firefighting tube nozzle of the junction portion of the coupling 29 is formed of a plurality of the mobile type tube nozzle at the firefighting cable car 256; and
said firefighting sensor pump body 1 is formed in such a manner that the cable car 256 is assembled by installing the steel towers 116 for the operations of the car 256 at each portion of the firefighting operation room 394 and along the ridges of the lower side of the ground surface GLL of the low or high mountain 395 and the peak of the same, and the portions near beaches and the roof of the low or high rise building, and the steel tower 116 is fixed with an anchor bolt 133 using a hand-held tool, and a driving wheel roller 135 and a pulley 256 formed of a plurality of wire ropes 19 are installed at the upper sides of the steel tower, and the winch 137 is installed at each portion of the peak of the mountain and the firefighting operation room 394 of the roof of the building below the steel tower 116, and the winch 137 receives the power of the transformer 96 and the electric pole 95 connected via electric cables with respect to the driving power 46 generated from the generator 213 or the engine generator 226 of the power plant 267 below the cable car 256, and there are provided the motored driving force motor 192 having a micro control function, and a plurality of the driving force motor 192 and the control module 106 with the sensor detections of a plurality of electronic valves at a plurality of compressors, and the firefighting cable car 256 is formed of the hole 20 of the firefighting tube nozzle 10 distributing the weights of the thing of the firefighting water 7 in the interior of the firefighting hose 9 in the water collection tank 34 of the plastic tent 43 integrally formed at the pump fire extinguisher 124 attached to the wire rope 19, and an air ship 78 and a rope 131 are connected with a plurality of ad balloons 77, respectively, above the life rescue basket 42; and
the driving motor 198 of the pump 8 is attached to the upper surfaces of the upright type multi-stage pump 8 and the diaphragm pump 144, and the diaphragm pump (ordinary pump) 144 is formed in such a manner that the piston 127 and the cylinder 126 are attached to a crank handle formed of the crank 248 and the link 249 on the rubber membrane or the upper side of the Teflon membrane 538, and the air receiver storing tank 145 formed of the air compressor 80 and the air tube line 181 formed of the air hose 109 and the nipple 110 is configured so that the gas container 171 storing the disaster prevention materials in the intercooler 170 and the pump fire extinguisher 124 after mounting it at the firefighting cable car 256, and is engaged in the interior of the firefighting sensor pump body 1.

2. A mobile tube nozzle firefighting sensor pump for a firefighting product for prevention disasters in a firefighting sensor pump wherein a mountain fire can be extinguished within one second using a water hammer pump 393 of a non-motored pump without receiving a driving force power 46 from a generator 213 of a power plant 267 or an engine generator 226, comprising:
a non-motored firefighting sensor pump body 1 is configured in such a manner that the water hammer pump 393 is characterized in a way of a water hammer (water hammering operation 389) generating a high pressure when the water positioned at a higher position is forced to flow fast and then is fast closed, without using a diving force pump or a compressor, and an induction tube is installed at each water collection tank 34 formed at a portion of a lower surface of the spring of a valley using a plurality of induction tubes 191 at the lower surfaces of the head tank 189 of each ridge formed to adjust the position energy same as the head tank 189 introduced into the introduction tube positioned at the upper surface of the generator 267, and then a separation and engaging type of a flange 28 is provided at the lower side of the high pressure bowl tank 303 formed at the upper surface of the water collection tank 34 and the upper surface of the water collection tank 34 for an easier maintenance of the check calve (butterfly type 453) at the junction portion; and a water pumping tube 89 formed of a socket of a semi-elbow 44 (angle is 45 degrees) at the horizontal central lower portion of the things of the bowl tank 303, and there is provided a no-motored type firefighting sensor pump body 1 formed of a spring type safety valve 473 at a front side of the induction tube 191 below the upper side of the water collection tank; and when firefighting water is forced to flow to the induction tube 191, and the firefighting water is stored via the suction port 269 of a plurality of head tanks 189 installed along a ridge of the mountain, and the firefighting water 7 is discharged at a certain pressure as the check valve (lift type check valve 453) is opened when the pressure in the interior of the tank 34 sharply increases in which the safety value 473 is closed by flowing speed at the front side of the interior of the tank of the suction port 269 of the water collection tank 34 installed below a portion where the induction tube 191 of the discharge port of the tank 189 is installed, thus pumping firefighting water, and at this time, pumping is possible to 50 times the head drop by means of the water hammering operation, and the when the pressure rise 389 is removed, the lift type check valve 453 is closed, and the pumping of the firefighting water 7 can be performed with the aid of the air pressure in the interior of the high pressure bowl tank 303, and when the pressure of the front side of the safety valve 473 drops, the valve 473 is opened by means of the force of the spring 186, and the firefighting water 7 is inputted into the induction tube 191, and the above operations are repeated thus pumping, and a plurality of the water hammer pumps 393 are integrally formed in a stair shape at each ridge with the aid of the water hammering operation 389; and
said firefighting sensor pump body 1 is formed in such a way that a plurality of flanges 28 formed in a body of the tube 14 with a plurality of nozzle process holes and a plurality of gap process holes 20 in an assembling and disassembling manner in the body of a plurality of fixing type firefighting nozzles 10 formed at a distance of 50m away from the mano matten level type firefighting hose 9 at the lower surface of the water tank 259 of the upper end GLU of the ground surface of the peak of the mountain in the interior of the stair-shaped water hammer pump 393 at each ridge of the mountain, and the bolt 24 is inserted into the flange bolt connection hole 20, and the nut 25 is engaged to the bolt screw tap and is tightened by a hand-held spanner, and the water hammer pump 393 integrally formed with the paraffin nozzle cap 100 by the unit of 15 meter of the firefighting hose discharges the air compressed by the air compressor 87 through the hole formed at the lower side of the pumping tube 89 toward the upper surface of the water, and the foam pump (non-motored pump) is capable of pumping water up by a few kilometers to the peak of the mountain by using the flexible high pressure hose 190 with the aid of the hydraulic device using a cloth 75 at a rubber member, so the discharge water 38 and curtain water membrane 39 continuously drop from the body of the firefighting nozzle 10 with the firefighting disaster prevention pipe line 168, thus implementing a universal type non-motored pump having the top priority over all the areas of Korean peninsula mounting to 2400 square kilometer area based on one reference of the triangle point near DMZ including the area all over the world, and the firefighting sensor pump body 1 is internally configured with the unmanned camera 184 of the electronic sensor valve and the management system in the water storing tank.

3. The mobile tube nozzle firefighting sensor pump for a firefighting product for prevention disasters in a firefighting sensor pump according to claim 1, wherein a high pressure and low speed type air compressor 80 and an intercooler 170 are characterized to saving lives with the aid of a connection apparatus formed of a suction port 269 and a discharge port 270 integral with a two-stage screw compressor in which heat can distribute to the oil cooler 151 without using the after cooler 181, and the air tube 130 is formed of a bed nozzle 172, and the firefighting sensor pump body 1 formed of a ceiling partition curtain water membrane 39 is engaged in the interior of the building.
